(19) United States
(12) Patent Application Publication
(10) Pub. No.: US 2009/0117348 A1
(43) Pub. Date: May 7, 2009

(54) COMPOSITION FOR PRODUCING BOARD AND PRINTED CIRCUIT BOARD USING THE SAME

(75) Inventors: Chung Kun Cho, Suwon-si (KR); Myung Sup Jung, Seongnam-si (KR); Yoo Seong Yang, Daejeon (KR); Sang Hyuk Suh, Daejeon (KR); Bon Hyeok Gu, Hwaseong-si (KR)

Correspondence Address: CANTOR COLBURN, LLP, 20 Church Street, 22nd Floor, Hartford, CT, 06103, US

(73) Assignees: Samsung Electronics Co.,Ltd., Suwon-si (KR); Samsung Electro-Mechanic Co., Ltd., Suwon-si (KR); Samsung Fine Chemicals Co., Ltd., Ulsan (KR)

(21) Appl. No.: 12/263,598

(22) Filed: Nov. 3, 2008

(30) Foreign Application Priority Data
Nov. 2, 2007 (KR) 10-2007-0111686
Jan. 7, 2008 (KR) 10-2008-0001698
Oct. 15, 2008 (KR) 10-2008-0100980

(51) Int. Cl. B32B 3/02; C08L 77/06; C08L 81/08; C08K 5/20; C08K 5/3415; C08K 5/3412; C08K 5/41; C08K 5/1535; B32B 15/08; C08K 5/10; C08L 67/00; C08G 69/02; C08G 73/02; C08G 73/10; C08G 18/71

(52) U.S. Cl. 428/195.1; 524/606; 524/612; 524/609; 524/592; 524/607; 524/233; 524/104; 524/98; 524/173; 524/285; 524/317; 524/599; 528/331; 528/422; 528/322; 528/69; 428/458

(57) ABSTRACT

Compositions for producing a board and a printed circuit board produced using the composition are provided. The compositions can be used for the production of a variety of printed circuit boards.

This application claims priority to Korean Patent Application No. 10-2007-111686, filed on Nov. 2, 2007, Korean Patent Application No. 10-2008-1698, filed on Jan. 7, 2008, and Korean Patent Application No. 10-2008-100980, filed on Oct. 15, 2008, and all the benefits accruing therefrom under 35 U.S.C. §119, the contents of which are herein incorporated by reference in their entirety.

### BACKGROUND

1. Field

The present disclosure is directed to a composition for producing a board and a printed circuit board using the composition. More specifically, the composition comprises a thermally curable aromatic oligomer that contains at least one soluble structural unit in the backbone and has at least one end thereof a thermally curable group.

2. Description of the Related Art

Recent advances in information and communication technologies have transformed our society into a high-tech communication and information society based on the convergence of computers and communication devices. The trend toward miniaturization and high performance of electronic devices, for example, mobile phones and personal computers, has led to high-density integration of printed circuit boards as essential elements of electronic devices. Such high-density integration is achieved by the layering of printed circuit boards, the reduction in the thickness of printed circuit boards, the reduction in the diameter and interval of through-holes, etc. However, in accord with these advances, there is a commensurate need for novel board materials with improved performance to complement the miniaturization of circuits.

The use of high operating frequencies for rapid processing of data in electronic information devices such as computers involves the problems of transmission loss and signal delay. In an effort to solve such problems, it is necessary to make use of copper clad laminates with low dielectric constant and low dielectric loss tangent. Generally, a signal delay in a printed circuit board increases linearly with the square root of the relative permittivity of an insulating material around interconnection lines. Thus, low-permittivity resin compositions are needed to produce boards requiring a high transmission rate.

FR-4 copper clad laminates, which are the most common type of boards, suffer from the problems of increased transmission loss and signal delay because of their relatively high permittivity (ca. 4.5-5.5). However, these board materials fail to provide a satisfactory balance of performance results, including for example, improved mechanical properties, high heat resistance, low thermal expansion and low moisture absorption properties, for future packaging technologies. Thus, there is a need to develop novel materials that meet the requirements for next-generation boards.

### SUMMARY

Disclosed herein is, in an embodiment, a composition for producing a board comprising a thermally curable aromatic oligomer and a solvent, wherein the thermally curable aromatic oligomer contains at least one soluble structural unit in the backbone and has at least one end thereof a thermally curable group(s).

The soluble structural unit may be a C₄-C₃₀ arylamine or arylamide group.

The thermally curable groups are thermally crosslinkable reactive groups, and may be include maleimide, nadimide, phthalimide, acetylene, propargyl ether, benzocyclobutene, cyanate, and substituents and derivatives thereof. The composition may further comprise a toughening agent.

In another embodiment, a thermally curable aromatic oligomer is represented by Formula 6:

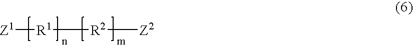

wherein R¹ is at least one soluble structural unit selected from the following structural units of Formula (2):

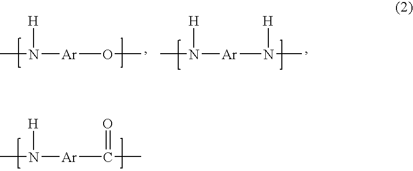

wherein each Ar is independently a C₄-C₃₀ aryl group, R² is at least one structural unit selected from the following units of Formula (5).

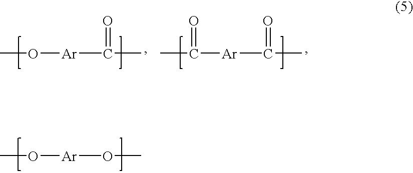

wherein each Ar is independently a C₄-C₃₀ aryl group, Z¹ and Z², which are identical to or different from each other, each represents a group selected from the group consisting of hydrogen, halogen, hydroxyl, maleimide, nadimide, phthalimide, acetylene, propargyl ether, benzocyclobutene, cyanate, and substituents and derivatives thereof, and at least one of Z¹ and Z² are selected from the group consisting of maleimide, nadimide, phthalimide, acetylene, propargyl ether, benzocyclobutene, cyanate, and substituents and derivatives thereof, and m and n satisfy the relations of 1≦m≦50, 1≦n≦50 and 0.05<n/(n+m+2)≦0.6. In another embodiment, a prepreg comprises the cure product of a thermally curable aromatic oligomer represented by Formula 6, and a glass fiber cloth.

In another embodiment, a prepreg comprises the cure product of a thermally curable aromatic oligomer containing at 10 least one soluble structural unit in the backbone and at least one end of the thermally curable oligomer comprises a thermally curable group, and a glass fiber cloth, wherein the soluble structural unit comprises one or more structural units selected from the following group of Formula (1):

X¹—Ar—Y¹ (1)

wherein Ar is a C₄-C₃₀ aryl group; X¹ and Y¹, which are identical to or different from each other, are independently selected from the group consisting of O, NR and CO, wherein at least one of the group consisting of X¹ and Y¹ is NR, wherein R is selected from the group consisting of hydrogen atom, C₁-C₂₀ alkyl group, and C₆-C₃₀ aryl group, and

wherein the thermally curable group is selected from the group consisting of maleimide, nadimide, phthalimide, acetylene, propargyl ether, benzocyclobutene, cyanate, and substituents and derivatives thereof.

Also disclosed herein is a prepreg or a printed circuit board produced using the composition.

### BRIEF DESCRIPTION OF THE DRAWINGS

The exemplary embodiments will be more clearly understood from the following detailed description taken in conjunction with the accompanying drawings, where:

FIG. 1 is a ¹H-NMR spectrum of an exemplary thermally curable aromatic oligomer synthesized in Preparative Example 4-2; and

FIG. 2 is a differential scanning calorimetry (DSC 2010, TA Instrument) thermogram showing the reaction temperature profile of an exemplary thermally curable aromatic oligomer synthesized in Preparative Example 4-2.

### DETAILED DESCRIPTION OF THE EMBODIMENTS

Exemplary embodiments will now be described in greater detail hereinafter with reference to the accompanying drawings, in which embodiments are shown.

These exemplary embodiments may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on, the other element or intervening elements may be present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be described in detail with reference to the accompanying drawings.

In an embodiment, a composition for producing a board comprises a thermally curable aromatic oligomer and a solvent wherein the thermally curable aromatic oligomer contains at least one soluble structural unit in the backbone and has at least one end thereof a thermally curable group. As used herein, “soluble” means capable of being dissolved in the solvent used in the composition.

Generally, melting or dissolution of a polymer resin in a solvent is not effective in increasing the solids content due to the high viscosity of polymer resins. The high viscosity polymer resins used in comparative compositions make it difficult to impregnate, for example, a glass fiber cloth with the composition. A low solids content of the polymer resin composition would lead to a reduction in the amount of the composition impregnated into the glass fibers to cause the need for reprocessing, inevitably incurring considerable processing costs. In contrast, the thermally curable aromatic oligomer has a low viscosity, exhibits excellent characteristics in terms of dielectric constant, coefficient of thermal expansion and moisture resistance, and is highly soluble in a solvent. Based on these advantages, the composition comprising the thermally curable aromatic oligomer can be used for the production of a variety of boards at reduced cost.

In an embodiment, the soluble structural unit is a moiety incorporated into the backbone of the thermally curable aromatic oligomer and may be a C₄-C₃₀ arylamine or arylamide group.

In a specific embodiment, the soluble structural unit may be selected from the group consisting of, but not necessarily limited to, the following structural units of Formula (1):

X¹—Ar—Y¹ (1)

wherein Ar is a C₄-C₃₀ aryl group; X¹ and Y¹, which are identical to or different from each other, are independently selected from the group consisting of O, NR and CO, wherein at least one of the group consisting of X¹ and Y¹ is NR, wherein R is selected from the group consisting of hydrogen atom, C₁-C₂₀ alkyl group, and C₆-C₃₀ aryl group.

In a more specific embodiment, the soluble structural unit may be selected from the group consisting of, but not necessarily limited to, the following structural units of Formula (2):

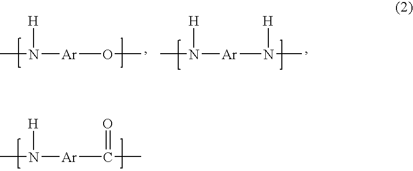

wherein each Ar is independently a C₄-C₃₀ aryl group.

In an embodiment, the soluble structural unit may include two or more of the structural units of Formula (1). In such an exemplary embodiment, each of the aryl groups (Ar), which are identical or different, may be unsubstituted or substituted with an amide, ester, carboxyl, alkoxy, aryl or trifluoromethyl group.

Non-limiting exemplary embodiments of Ar include the following aryl group of Formula (3):

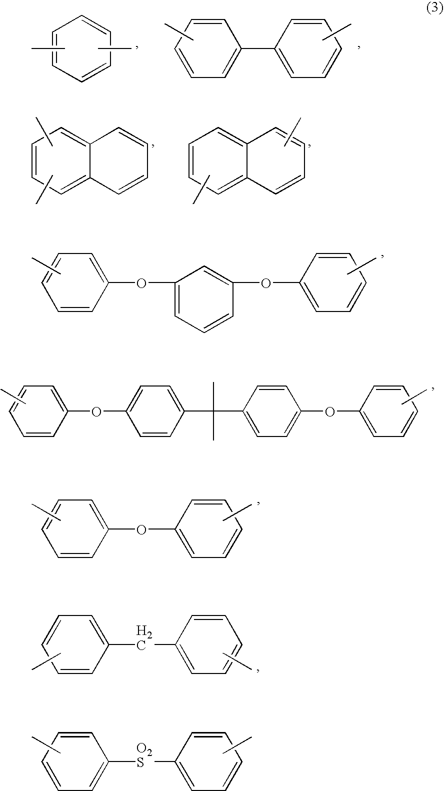

In an embodiment, the soluble structural unit may be present at a level greater than 5 mol % and less than or equal to 60 mol %, based on the total moles of all constituent structural units of the aromatic oligomer. If the content of the soluble structural unit is less than 5 mol %, improvement in the solubility of the aromatic oligomer in the solvent is negligible. Likewise, if the content of the soluble structural unit is greater than 60 mol %, the aromatic oligomer becomes hydrophilic, resulting in deterioration of moisture resistance. The content of the soluble structure unit can be adjusted to a desired level by varying the amounts of constituent monomers added during preparation of the soluble structure unit. For example, the size, weight, characteristics and chemical composition of the soluble structural unit may be varied to accomplish the desired content level of the soluble structural unit in the aromatic oligomer.

In an embodiment, the thermally curable aromatic oligomer further contains one or more structural units selected from the following group of Formula (4) in the oligomer chain in addition to the thermally curable group:

X²—Ar—Y² (4)

wherein Ar is a C₄-C₃₀ aryl group; X² and Y², which are identical to or different from each other, are independently O or CO.

The structural units of Formula (4) may be selected from the following units of Formula (5) in the backbone:

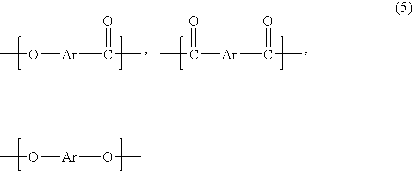

wherein each Ar is independently a C₄-C₃₀ aryl group.

When two or more of the soluble structural unit (3) are included in the aromatic oligomer, each of the aryl groups (Ar), which are identical or different, may be unsubstituted or substituted with an amide, ester, carboxyl, alkoxy, aryl or trifluoromethyl group.

Non-limiting exemplary embodiments of Ar include the following aryl group of Formula (3):

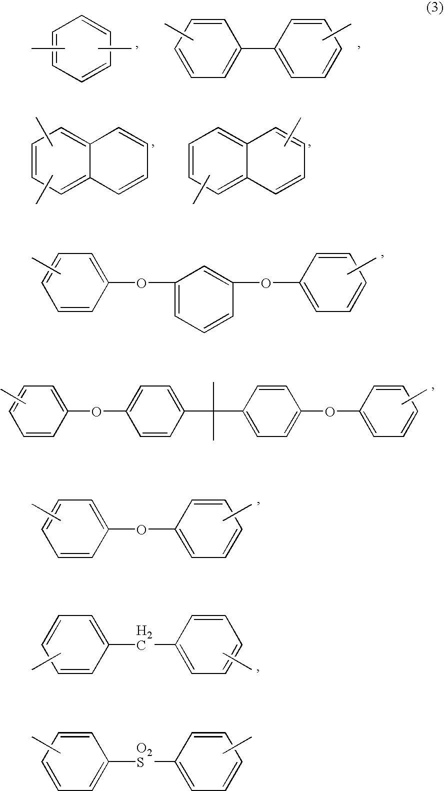

The thermally curable aromatic oligomer may have at least one end thereof a thermally curable group(s). The thermally curable aromatic oligomer may have a thermally curable group at one of the two ends of the oligomer. Alternatively, the thermally curable aromatic oligomer may have more than one thermally curable groups at both ends thereof Each thermally curable group may be identical or different. When the composition undergoes high-temperature curing during production of a board (e.g., a printed circuit board), the thermally curable groups are crosslinked to form a stable, rigid network-like structure, resulting in an improvement in the mechanical properties of the final board.

The thermally curable groups may be reactive groups that can be crosslinked by heat. Exemplary embodiments of the thermally curable groups include, but are not necessarily limited to, maleimide, nadimide, phthalimide, acetylene, propargyl ether, benzocyclobutene, cyanate, and substituents and derivatives thereof. The term “substituents,” as used herein, refers to a number of substituents wherein a part of terminal groups of the thermally curable groups are substituted from halogen, alkyl, aryl, and the like. In the case of maleimide as an end group, the substituents as used herein are defined to include structures in which at least one hydrogen atom in the double bond of the maleimide is substituted with an alkyl group (e.g., methyl). The term “derivatives” as used herein are intended to encompass structures in which the thermally curable groups are fused to an aromatic group or a fused cycloaromatic group. For example, the double bond of the maleimide may be fused to a benzene or naphthalene ring.

The thermally curable aromatic oligomer may be represented by Formula 6:

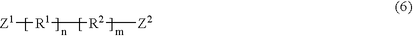

wherein R¹ is at least one soluble structural unit selected from the structural units of Formula (2);

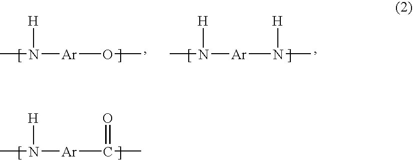

wherein each Ar is independently a C₄-C₃₀ aryl group, R² is at least one structural unit selected from the units of Formula (5);

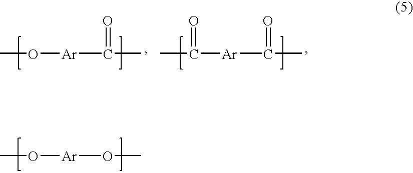

wherein each Ar is a C₄-C₃₀ aryl group,

Z¹ and Z², which are identical to or different from each other, each represents a group selected from the group consisting of hydrogen, halogen, hydroxyl, maleimide, nadimide, phthalimide, acetylene, propargyl ether, benzocyclobutene, cyanate, and substituents and derivatives thereof, and at least one of Z¹ and Z² are selected from the group consisting of maleimide, nadimide, phthalimide, acetylene, propargyl ether, benzocyclobutene, cyanate, and substituents and derivatives thereof; and

m and n are independently a positive integer and satisfy the relations of 1≦m≦50, 1≦n≦50 and 0.05<n/(n+m+2)≦0.6.

A thermally curable aromatic oligomer may be represented by Formula 7 or 8:

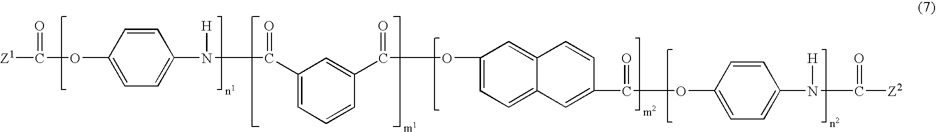

wherein Z¹ and Z², which are identical to or different from each other, are independently selected from the group consisting of maleimide, nadimide, phthalimide, acetylene, propargyl ether, benzocyclobutene, cyanate, and substituents and derivatives thereof, and m¹, m², n¹ and n² satisfy the relations of 1≦m₁+m₂≦50, 1≦n₁+n₂≦50; or

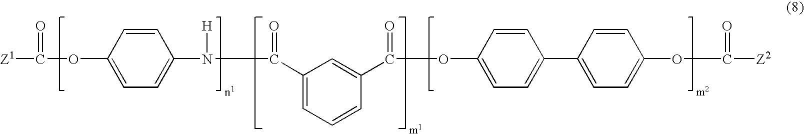

wherein Z¹ and Z², which are identical to or different from each other, are independently selected from the group consisting of maleimide, nadimide, phthalimide, acetylene, propargyl ether, benzocyclobutene, cyanate, and substituents and derivatives thereof, and and m¹, m² and n¹ satisfy the relations of 1≦m₁+m₂≦50, 1≦n₁≦50.

The ratio n/(n+m+2) in Formulae 6 to 8 is greater than 0.05 and less than or equal to 0.6.

The thermally curable aromatic oligomer may have a number average molecular weight (Mw) of 500 to 15,000 g/mol. An aromatic oligomer having a number average molecular weight less than 500 g/mol is likely to be brittle due to its high crosslinking density. Meanwhile, the use of an aromatic oligomer having a number average molecular weight greater than 15,000 g/mol may causes an increase in the viscosity of the composition, which would makes it difficult to impregnate a glass fiber cloth with the composition.

There is no particular restriction on the preparation method of the thermally curable aromatic oligomer. For example, the thermally curable aromatic oligomer can be prepared by the following procedure. First, monomers are prepared for the preparation of an aromatic oligomer containing at least one soluble structural unit by polymerization. The monomers are reacted with a compound capable of introducing one or more thermally curable groups into the aromatic oligomer.

The monomers can be selected from the group consisting of, but are not particularly limited to: aromatic, aromatic heterocyclic and aliphatic dicarboxylic acids; aromatic, aromatic heterocyclic and aliphatic diols; aromatic, aromatic heterocyclic and aliphatic diamines; aminophenols; hydroxybenzoic acids; and aminobenzoic acids. Specifically useful are aromatic, aromatic heterocyclic and aliphatic diols, aminophenols, and aminobenzoic acids.

Solution polymerization or bulk polymerization can be carried out in a single reaction tank equipped with suitable stirring means to prepare the thermally curable aromatic oligomer.

The preparation of the thermally curable aromatic oligomer by solution polymerization will be explained below. In the polymerization, isophthaloyl chloride, aminophenol, 2,6-dihydroxynaphthalene and triethylamine are reacted in a reactor with stirring at ambient temperature. After the passage of a predetermined time, the reaction mixture is reacted with a compound (e.g., 4-maleimidobenzoyl chloride) capable of providing thermally curable groups as end groups to obtain a crude product. The crude product is isolated and purified by removal of the solvent and other volatiles to give the desired thermally curable aromatic oligomer.

Alternatively, the thermally curable aromatic oligomer is prepared by a bulk polymerization process in accordance with the following procedure. In the polymerization, isophthalic acid, aminophenol, 2-hydroxy-6-naphthoic acid and acetic anhydride are introduced into a reactor and slowly heated (about 15 minutes to about 3 hours) to a temperature of about 150° C. with stirring. The mixture is then refluxed for 3 hours. Acetic acid as a by-product and unreacted acetic anhydride are removed from the reaction mixture by distillation. After 4-hydroxybenzoic acid is added, the temperature is raised to about 320° C. and the reaction is allowed to proceed. As a result of the reaction, an aromatic oligomer terminated with one or more alcohol groups in the backbone is synthesized. The aromatic oligomer is dissolved in an appropriate reaction solvent (e.g., DMF), and then a compound capable of providing thermally curable groups as end groups is added to the solution. The mixture is allowed to react to give a thermally curable aromatic oligomer having at least one end thereof a thermally curable group(s).

Another bulk polymerization process for the preparation of the thermally curable aromatic oligomer can be carried out by the following procedure. In the polymerization, isophthalic acid, aminophenol, 2-hydroxy-6-naphthoic acid and acetic anhydride are introduced into a reactor and slowly heated (about 15 minutes to about 3 hours) to a temperature of about 150° C. with stirring. The mixture is allowed to react at reflux for a predetermined time period. Acetic acid as a by-product and unreacted acetic anhydride are removed from the reaction mixture by distillation. After nadimidobenzoic acid is added, the temperature is raised to about 250° C. The mixture is allowed to react to give the thermally curable aromatic oligomer.

The composition is applicable to solvent casting to facilitate the impregnation into a suitable material such as glass fiber. There is no particular restriction on the kind of the solvent used in the composition. The solvent may be a polar aprotic solvent. In an embodiment, the polar aprotic solvent can be selected from the group consisting of N,N-dimethylacetamide, N-methylpyrrolidone (“NMP”), N-methylcaprolactam, N,N-dimethylformamide, N,N-diethylformamide, N,N-diethylacetamide, N-methylpropionamide, dimethylsulfoxide, γ-butyrolactone, dimethylimidazolidinone, tetramethylphosphoramide, and ethyl cellosolve acetate. These aprotic solvents may be used alone or as a mixture of two or more thereof. In an embodiment, the composition may comprise 0.1 to 300 parts by weight of the thermally curable aromatic oligomer, based on 100 parts by weight of the solvent.

The composition may further include a toughening agent. The combination of the thermally curable aromatic oligomer and the toughening agent makes the final composition more flexible. The toughening agent may be an aromatic polymer having a number average molecular weight (Mn) of about 2,000 to about 500,000 g/mol. Exemplary embodiments of the aromatic polymer include, but are not necessarily limited to, those that contain one or more mesogen groups selected from the group consisting of ester, ester-amide, ester-imide, ester-ether and ester-carbonate in the backbone chain. In one exemplary embodiment, the thermally curable aromatic oligomer and the toughening agent may be mixed in a weight ratio of 99.5:0.5 to 35:65.

The composition may have a solids content of 5% to 100% by weight, specifically 5% to 95% by weight, more specifically 30% to 95% by weight, and still more specifically 50% to 95% by weight with respect to the weight of the composition. The high solubility of the thermally curable aromatic oligomer leads to an increase in the solids content of the composition.

The composition may optionally further comprise one or more additives selected from fillers, softeners, plasticizers, lubricants, antistatic agents, colorants, antioxidants, heat stabilizers, light stabilizers and UV absorbers. Exemplary embodiments of the fillers include organic fillers, such as epoxy, melamine, urea, benzoguanamine and styrene resin powders, and inorganic fillers, such as silica, alumina, titanium oxide, zirconia, kaolin, calcium carbonate and calcium phosphate.

The composition can be used as a packaging material due to its good adhesion to a copper foil, high heat resistance, low thermal expansion and excellent mechanical properties. The composition can be molded into a board or prepared into a varnish for impregnation or coating applications. Other applications of the composition include laminates, printed boards, constituent layers of multilayer boards, copper clad laminates (e.g., resin-coated copper (“RCC”) and copper clad laminates (“CCL”) and tape-automated bonding (“TAB”) films, but are not limited thereto.

For example, a board can be produced by casting the composition, which comprises the thermally curable aromatic oligomer, the solvent and optionally the toughening agent, on a substrate, followed by heat curing. The addition of the toughening agent improves the flexibility of the final composition to offer the advantage of ease of handling during copper foil lamination.

In another embodiment, a prepreg is produced using the composition. In one exemplary embodiment, the prepreg can be produced by impregnating the composition into a reinforcing material. Specifically, a reinforcing material is impregnated with the composition, cured, and formed into a sheet to produce the desired prepreg. Non-limiting exemplary embodiments of the reinforcing material include glass cloth, woven alumina glass fibers, glass fiber non-woven fabrics, cellulose non-woven fabrics, woven carbon fibers, and polymer fabrics. The impregnation can be carried out by any technique known in the art, such as for example dip coating or roll coating. In an embodiment, a prepreg comprises the cure product of a thermally curable aromatic oligomer, and a glass fiber cloth.

In another embodiment, a board is produced from the composition. Exemplary embodiments of the board include, but are not particularly limited to, constituent layers of multilayer boards, metal clad laminates and printed boards. The board may be a combination of the prepreg and a metal foil.

In one exemplary embodiment, the board may be in the form of a film. Any process may be used to form the composition into a thin film. Suitable film formation processes include, but are not limited to: extrusion molding in which the composition is extruded through a die of an extruder to form a film, cast molding in which the composition is cast into a film, and dip molding in which an inorganic substrate (e.g., glass) or a fabric substrate is dipped in a varnish composed of the composition and is then molded into a film.

In an exemplary embodiment, the board may be laminated with a metal foil. Exemplary embodiments of the metal foil include copper and aluminum foils. The thickness of the metal foil may vary from 5 to 100 μm depending on the desired application of the board. A printed circuit board can be produced by performing circuit processing on a metal foil of a metal foil-coated laminate. A multilayer printed circuit board can be produced by stacking a metal foil-coated laminate on a printed laminate, followed by circuit processing.

The metal foil laminate may be produced by applying the composition to a metal foil (e.g., a copper foil) or casting the composition on a metal foil (e.g., a copper foil), removing the solvent, followed by annealing. The solvent is preferably removed by evaporation. The evaporation is carried out by heating under reduced pressure or by flushing.

The composition can be applied by various processes, including for example roll coating, dip coating, spray coating, spin coating, curtain coating, slot coating and screen printing. It is preferred to remove fine impurities contained in the composition solution by filtration before application to or casting on a copper foil.

Exemplary embodiments of the metal foil laminate may include, but are not particularly limited to, resin-coated copper (RCC) and copper clad laminates (CCL).

In another embodiment, a thermally curable aromatic oligomer is represented by Formula 6:

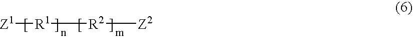

wherein R¹ is at least one soluble structural unit selected from the following structural units of Formula (2):

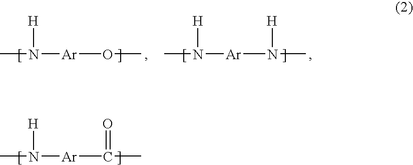

wherein each Ar is a C₄-C₃₀ aryl group; R² is at least one structural unit selected from the following units of Formula (5);

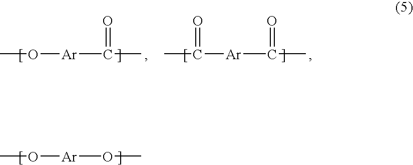

wherein each Ar is independently a C₄-C₃₀ aryl group; Z¹ and Z², which are identical to or different from each other, each represents a group selected from the group consisting of hydrogen, halogen, hydroxyl, maleimide, nadimide, phthalimide, acetylene, propargyl ether, benzocyclobutene, cyanate, and substituents and derivatives thereof; at least one of Z¹ and Z² is selected from the group consisting of maleimide, nadimide, phthalimide, acetylene, propargyl ether, benzocyclobutene, cyanate, and substituents and derivatives thereof; and m and n are independently a positive integer and satisfy the relations of 1≦m≦50, 1≦n≦50 and 0.05<n/(n+m+2)≦0.6.

In an embodiment, each Ar in the structural units of Formula (2) and (5) may be selected from the group consisting of the following aryl group of Formula (3):

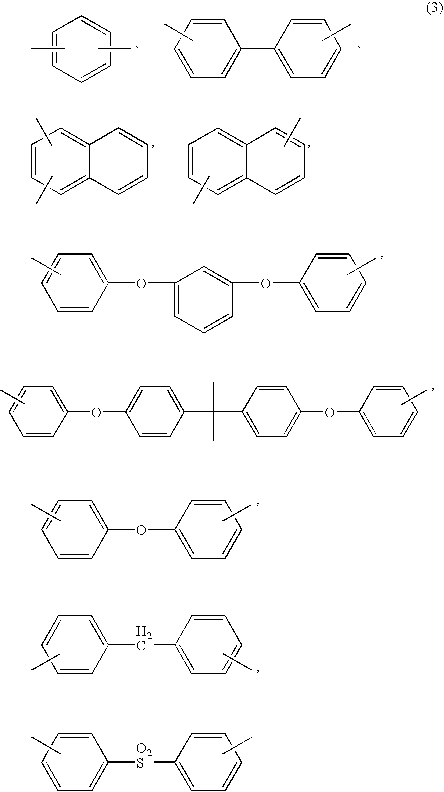

R¹ and R² in Formula (6) may be arranged randomly or in blocks. Exemplary arrangements of the structural units (R¹ and R²) and the thermally curable groups (Z¹ and Z²) in the thermally curable aromatic oligomer of Formula 6 include Z¹R¹R¹R¹ . . . R²R²R²Z², Z¹R¹R¹R² . . . R¹R¹R¹Z², Z¹R¹R²R²R² . . . R¹R²Z² and Z¹R¹R²R¹R² . . . R¹R²Z². In an embodiment, a prepreg comprises the cure product of a thermally curable aromatic oligomer of formula 6, and a glass fiber cloth.

A more detailed description of the embodiments will be described in more detail with reference to the following examples. However, these examples are given merely for the purpose of illustration and are not to be construed as limiting the scope of the embodiments.

### EXAMPLES

### Preparative Example 1

### 1-1: Synthesis of 4-maleimidobenzoyl chloride

29.4 g (0.300 mol) of maleic anhydride was slowly added to a solution of 41.1 g (0.300 mol) of p-aminobenzoic acid and 300 ml of acetic acid in a 250 ml flask at 10° C. to obtain a yellow precipitate. The precipitate was recrystallized from a solution of DMF/ethanol (50:50 (w/w)) to give an intermediate. The intermediate was treated with excess sodium acetate and acetic anhydride at 85° C. for 15 minutes, cooled to room temperature, and placed in an ice bath to obtain a precipitate. The precipitate was recrystallized from a solution of ethyl acetate/n-hexane (50:50 (w/w)) to yield N-(p-carboxyphenyl)maleimide.

15 g (0.07 mol) of the N-(p-carboxyphenyl)maleimide was added to 80 ml of benzene, and 21.83 g (0.172 mol) of oxalyl chloride was slowly added thereto. The mixture was refluxed for 2 hours. After the removal of unreacted oxalyl chloride, the reaction mixture was cooled to room temperature, filtered, and washed with hexane to afford 4-maleimidobenzoyl chloride.

### 1-2: Synthesis of Thermally Curable Aromatic Oligomer

3.274 g (0.030 mol) of 4-aminophenol, 4.655 g (0.025 mol) of 4,4-dihydroxybiphenyl and 18 ml of triethylamine were dissolved in 100 ml of dimethylformamide in a 250 ml flask. The flask was cooled in ice water and 10.151 g (0.050 mol) of isophthaloyl chloride was added to the flask. The mixture was allowed to warm to room temperature and react for 60 hours. The reaction mixture was purified by precipitation into water, washed with ethanol, and dried.

1 g of the dried sample was dissolved in 9 g of N-methyl pyrrolidone (“NMP”). To the solution were added 0.1 g of the 4-maleimidobenzoyl chloride prepared in Preparative Example 1 and 10 ml of triethylamine. The mixture was allowed to react at room temperature for 12 hours, affording a thermally curable aromatic oligomer having maleimide groups at least one end of the oligomer chain, as represented by Formula 9:

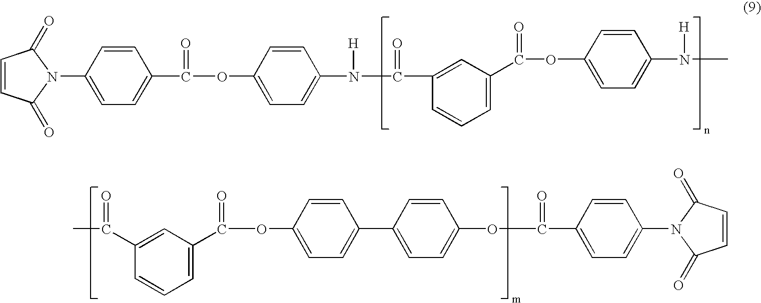

wherein m and n are each independently from 1 to 50.

### Preparative Example 2

### Synthesis of Thermally Curable Aromatic Oligomer

A thermally curable aromatic oligomer was synthesized in the same manner as in Preparative Example 1 except that 4-aminophenol and 4,4-dihydroxybiphenyl were used in amounts of 3.820 g (0.035 mol) and 3.724 g (0.020 mol), respectively.

### Preparative Example 3

### Synthesis of Thermally Curable Aromatic Oligomer

A thermally curable aromatic oligomer was synthesized in the same manner as in Preparative Example 1 except that 4-aminophenol and 4,4-dihydroxybiphenyl were used in amounts of 4.365 g (0.04 mol) and 2.793 g (0.015 mol), respectively.

### Preparative Example 4

### 4-1: Preparation of 4-nadimidobenzoic acid

32.83 g (0.200 mol) of 5-norbornene-2,3-dicarboxylic anhydride was added to 400 ml of glacial acetic acid in a 1,000 ml flask and heated to 110° C. to obtain a solution. To the solution was added 4-aminobenzoic acid in an excessively large amount (41.1 g, 0.300 mol). The mixture was allowed to react with stirring for 2 hours. The reaction mixture was left standing at room temperature to obtain a precipitate. The precipitate was washed sequentially with glacial acetic acid and water, and dried in a vacuum oven at 60° C. to afford 4-nadimidobenzoic acid (yield=95%).

### 4-2: Synthesis of Thermally Curable Aromatic Oligomer

10.798 g (0.065 mol) of isophthalic acid, 47.948 g (0.254 mol) of 6-hydroxy-2-naphthoic acid, 14.187 g (0.130 mol) of 4-aminophenol and 58.396 g (9.5 mol) of acetic anhydride were put into a 500 ml flask equipped with a condenser and a mechanical stirrer. After gradual heating to 140° C. under a nitrogen atmosphere, the mixture was allowed to react (acetylation) for 3 hours while maintaining the reaction temperature constant. Subsequently, 36.79 g (0.130 mol) of 4-nadimidobenzoic acid prepared in Preparative Example 4-1 was added to the reaction mixture and was then heated to 215° C. at a rate 1 to 2° C./min while removing acetic acid as a by-product and any unreacted acetic anhydride. The reaction was continued at 215° C. for 4 hours, yielding a thermally curable aromatic oligomer having nadimido groups at least one end of the oligomer chain, represented by Formula 10.

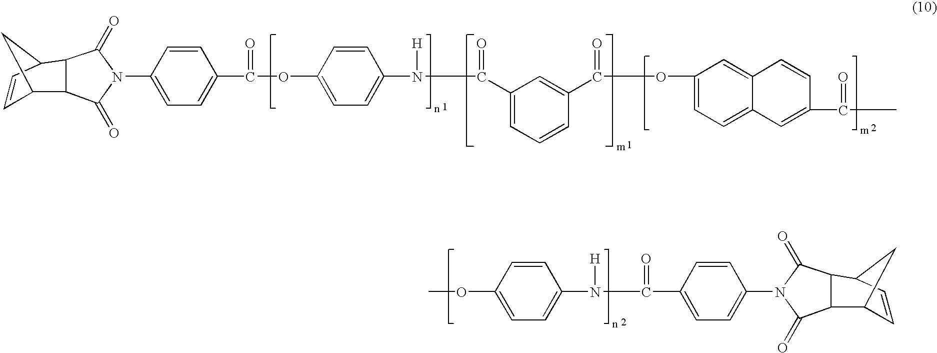

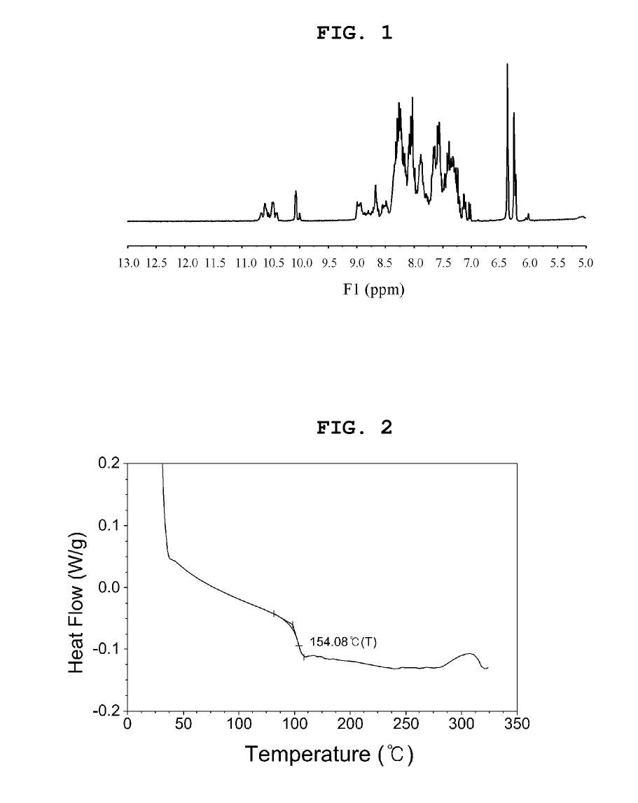

The introduction of reactive functional groups into both ends of the thermally curable aromatic oligomer was analyzed by NMR spectroscopy (DPX300, Bruker NMR). DMSO-d₆ was used as a solvent for the NMR analysis. As shown in FIG. 1, peaks corresponding to the nadimide were observed at δ 6.2-6.4, indicating the introduction of nadimide at both ends of the backbone. One skilled in the art will appreciate that in Formula 10, other combinations of repeating monomer units having 4-aminophenol condensed with 6-hydroxy-2-naphthoic acid to form an amide linkage, and nadimido end groups condensed to the hydroxy end of a 6-hydroxy-2-naphthoic acid unit, are also statistically probable though not depicted in Formula 10, and that the order of the repeating monomer units shown (in brackets) should not be considered as limited to the order shown.

The reaction temperature profile of the thermally curable aromatic oligomer synthesized in Preparative Example 4-2 was analyzed using a differential scanning calorimeter (DSC 2010, TA Instrument) while raising the temperature at a rate of 20° C./min to 320° C. The results are shown in FIG. 2. Peaks corresponding to reaction of the reactive functional groups were observed at 280-320° C., indicating that successful introduction of the reactive functional groups at both ends of the backbone.

### Preparative Example 5

16.613 g (0.100 mol) of isophthalic acid, 51.75 g (0.276 mol) of 6-hydroxy-2-naphthoic acid, 16.370 g (0.150 mol) of 4-aminophenol and 64.572 g (0.633 mol) of acetic anhydride were put into a 500 ml flask equipped with a condenser and a mechanical stirrer. After gradual heating to 140° C. under a nitrogen atmosphere, the mixture was allowed to react (acetylation) for 3 hours while maintaining the reaction temperature constant. Subsequently, 28.3 g (0.100 mol) of 4-nadimidobenzoic acid prepared in Preparative Example 4-1 was added to the reaction mixture and was then heated to 215° C. at a rate 1 to 2° C./min while removing acetic acid as a by-product and unreacted acetic anhydride. The reaction was continued at 215° C. for 4 hours, yielding a thermally curable aromatic oligomer having nadimide groups at least one end of the oligomer chain.

### Preparative Example 6

19.639 g (0.120 mol) of isophthalic acid, 53.142 g (0.282 mol) of 6-hydroxy-2-naphthoic acid, 17.461 g (0.160 mol) of 4-aminophenol and 67.649 g (0.663 mol) of acetic anhydride were put into a 500 ml flask equipped with a condenser and a mechanical stirrer. After gradual heating to 140° C. under a nitrogen atmosphere, the mixture was allowed to react (acetylation) for 3 hours while maintaining the reaction temperature constant. Subsequently, 22.640g (0.080 mol) of 4-nadimidobenzoic acid prepared in Preparative Example 4-1 was added to the reaction mixture and was then heated to 215° C. at a rate 1 to 2° C./min while removing acetic acid as a by-product and unreacted acetic anhydride. The reaction was continued at 215° C. for 4 hours, yielding a thermally curable aromatic oligomer having nadimide groups at least one end of the oligomer chain.

### Preparative Example 7

### Synthesis of Aromatic Polymer

8.3 g (0.05 mol) of isophthalic acid, 18.8 g (0.1 mol) of 6-hydroxy-2-naphthoic acid, 5.5 g (0.05 mol) of 4-aminophenol and 32.7 g (0.320 mol) of acetic anhydride were put into a 500 ml flask equipped with a condenser and a mechanical stirrer. After gradual heating to 150° C. under a nitrogen atmosphere, the mixture was allowed to react (acetylation) for 4 hours while maintaining the reaction temperature constant. After completion of the reaction, the reaction mixture was heated to 300° C. while removing acetic acid as a by-product and unreacted acetic anhydride. The reaction was continued for one hour, yielding an aromatic polymer (polyamide ester).

### Example 1

The solubility of each of the thermally curable aromatic oligomers synthesized in Preparative Examples 1-3 was evaluated by visually observing whether 1 g of the aromatic oligomer was dissolved in 10 g of N-methyl-2-pyrrolidone (NMP) at 160° C. The results are shown in Table 1. The solubility was judged to be ‘X’ when the aromatic oligomer was not dissolved at all, ‘Δ’ when the aromatic oligomer was partially dissolved, and ‘O’ when the aromatic oligomer was completely dissolved.

TABLE 1

| | Preparative | Preparative | Preparative |
|---|---|---|---|
| | Example 1 | Example 2 | Example 3 |
| Solubility | ∘ | ∘ | ∘ |

### Example 2

The molecular weights of the thermally curable aromatic oligomers synthesized in Preparative Example 4˜6 were measured relative to polystyrene standards with the use of gel permeation chromatography (GPC, VISCOTEK™ VE2001 GPCmax™ System). As a solvent, NMP was used and the results are shown in Table 2.

The thermally curable aromatic oligomer synthesized in Preparative Example 4˜6 was dissolved in NMP at 60° C. with a solid content of about 40% to obtain a brown solution. The aromatic oligomer was found to be highly soluble (˜40 wt %) in NMP.

In addition, the viscosity of the thermally curable aromatic oligomer solution was measured at room temperature and it was 1500 cP.

TABLE 2

| | Mₙ | M_{w} | PDI(M_{w}/Mₙ) |
|---|---|---|---|
| Preparative Example 4 | 3329 | 3902 | 1.17 |
| Preparative Example 5 | 3671 | 4406 | 1.20 |
| Preparative Example 6 | 4191 | 5232 | 1.25 |

### Examples 3-5

Each of the thermally curable aromatic oligomers prepared in Preparative Examples 1-3 was dissolved in NMP at 100° C. to obtain a composition for the production of a board. A glass fiber was placed on an electrodeposited copper foil fixed to the surface of a glass plate, and then the composition was homogeneously impregnated into the glass fiber structure. The impregnated specimen was cured by heating from room temperature to 300° C. Then, the cured specimen was dipped in a nitric acid (50 wt %) solution to completely remove the electrodeposited copper foil, leaving a clean impregnated glass fiber only.

The glass transition temperature (T_{g}) and the coefficient of thermal expansion (“CTE”) of the impregnated article were measured (Table 3). The CTE measurement was performed using a thermomechanical analyzer (TMA 2940, TA Instruments) under a nitrogen atmosphere at an elevated temperature (5° C./min).

TABLE 3

| | Example 3 | Example 4 | Example 5 |
|---|---|---|---|
| Thermally curable | Preparative | Preparative | Preparative |
| aromatic oligomer | Example 1 | Example 2 | Example 3 |
| Tg (° C.) | — | — | — |
| CTE (ppm/° C.) | 3.635 | 2.861 | 5.205 |

The results in Table 3 show that very low coefficients of thermal expansion (CTE) and no glass transition temperature were observed in the boards produced using the compositions, each of which contains the soluble structural unit.

### Examples 6-9

Thermally curable aromatic oligomers were prepared in the same manner as in Preparative Example 1 except that the molar ratio between 4-aminophenol and 4,4-dihydroxybiphenyl was changed to vary the content of the soluble structural unit (aminophenol moiety) as indicated in Table 4.

According to the procedure of Example 1, the thermally curable aromatic oligomers were used to prepare respective compositions and the solubility of the aromatic oligomers was measured. The results are shown in Table 4.

According to the procedure of Example 3, the compositions were used to produce glass fiber specimens, and the glass transition temperature (T_{g}) and the coefficient of thermal expansion (CTE) of the specimens were measured. The results are shown in Table 4.

TABLE 4

| | Example 6 | Example 7 | Example 8 | Example 9 |
|---|---|---|---|---|
| Content (mol %) of | 10 | 20 | 50 | 55 |
| soluble structural unit | | | | |
| Tg (° C.) | — | — | — | — |
| CTE (ppm/° C.) | 3.112 | 3.655 | 6.721 | 9.322 |
| Solubility | Δ | Δ | ∘ | ∘ |

From the results in Table 4, it is clear that the compositions were highly soluble and showed excellent thermal properties in terms of T_{g} and CTE.

### Example 10

3 g of the aromatic oligomer prepared in Preparative Example 1 and 7 g of the aromatic polymer (polyamide ester) prepared in Preparative Example 5 were dissolved in 40 g of NMP. The solution was impregnated into a glass fiber mat (size=40×40×0.05 (mm)) as a base to obtain a specimen. The specimen was placed on an electrodeposited copper foil and dried in a furnace for 2 hours while raising the temperature from room temperature to 300° C. The specimen was treated with an aqueous nitric acid solution (50 wt %) solution to completely remove the copper foil, leaving the prepreg only. The polymer was, in this way, impregnated into the glass fiber mat an amount of one part by weight of polymer per one part by weight of the glass fiber.

The glass transition temperature (T_{g}) and the coefficient of thermal expansion (CTE) of the prepreg were measured using a thermomechanical analyzer (TMA 2940, TA Instruments). The CTE measurement was performed under a nitrogen atmosphere at an elevated temperature (5° C./min). The results are shown in Table 5.

The flexibility of the prepreg was evaluated based on the following criteria: X′ when the base broke at a bending angle of 45°, ‘A’ when the base broke at a bending angle of 90°, and ‘O’ when no breakage of the base was observed at a bending angle of 90°. The results are shown in Table 5.

### Examples 11-12

Prepregs were produced in the same manner as in Example 10 except that the thermally curable aromatic oligomers prepared in Preparative Examples 1 to 3 were used.

The coefficients of thermal expansion of the prepregs were measured according to the same method as in Example 10. The results are shown in Table 5. Some of the prepregs were measured for glass transition temperatures and flexibility according to the same methods as in Example 10. The results are shown in Table 5.

TABLE 5

| | Example 10 | Example 11 | Example 12 |
|---|---|---|---|
| Thermally curable | Preparative | Preparative | Preparative |
| aromatic oligomer | Example 1 | Example 2 | Example 3 |
| T_{g} (° C.) | 244.37 | 281.80 | 281.75 |
| CTE (ppm/° C.) | 7.169 | 8.410 | 10.22 |
| Flexibility | ∘ | Δ | Δ |

It can be seen from the results in Table 5 that the prepregs were flexible and showed excellent thermal properties in terms of T_{g} and CTE.

### Example 13

Prepregs were produced in the same manner as in Example 10 except that the thermally curable aromatic oligomer prepared in Preparative Examples 4 were used.

The glass transition temperature of the prepreg was measured according to the same method as in Example 10. The Tg was measured as about 280° C. The coefficient of thermal expansion of the prepreg was measured according to the same method as in Example 10 and it was measured as 11 ppm/° C.

Although exemplary embodiments have been described herein with reference to the foregoing preferred embodiments, those skilled in the art will appreciate that various modifications and changes are possible without departing from the spirit of the invention as disclosed in the accompanying claims. Therefore, it is to be understood that such modifications and changes are encompassed within the scope of the invention.

What is claimed is:

1. A composition for producing a board comprising a thermally curable aromatic oligomer and a solvent wherein the thermally curable aromatic oligomer contains at least one soluble structural unit in the backbone and at least one end of the thermally curable oligomer comprises a thermally curable group.

2. The composition of claim 1, wherein the soluble structural unit is a C₄-C₃₀ arylamine group or a C₄-C₃₀ arylamide group.

3. The composition of claim 1, wherein the soluble structural unit comprises one or more structural units selected from the following group of Formula (1):
X¹—Ar—Y¹ (1)
wherein Ar is a C₄-C₃₀ aryl group; X¹ and Y¹, which are identical to or different from each other, are independently selected from the group consisting of O, NR and CO, wherein at least one of the group consisting of X¹ and Y¹ is NR, wherein R is selected from the group consisting of hydrogen atom, C₁-C₂₀ alkyl group, and C₆-C₃₀ aryl group.

4. The composition of claim 3, wherein the soluble structural unit is one or more structural units selected from the following group of Formula (2): 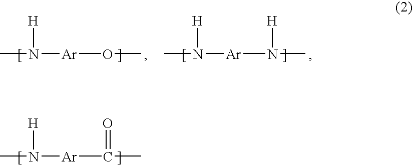
wherein each Ar is independently a C₄-C₃₀ aryl group.

5. The composition of claim 4, wherein Ar is an aryl group selected from the following group of Formula (3), or a substituent thereof:

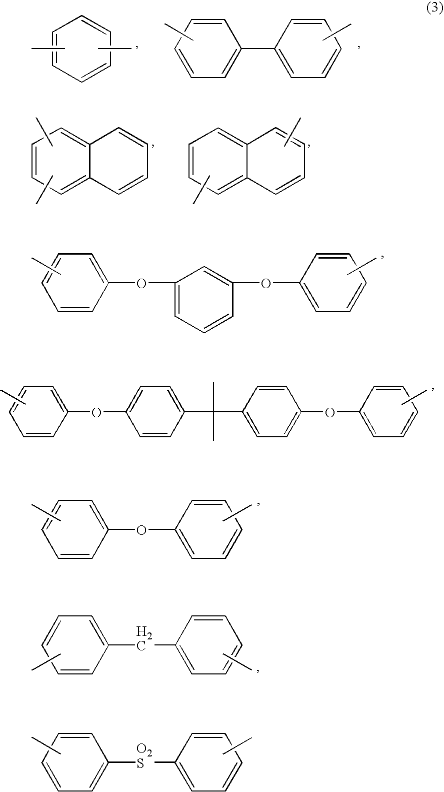

6. The composition of claim 1, wherein the soluble structural unit is present at a level higher than 5 mol % but not higher than 60 mol %, based on the total moles of all constituent structural units of the aromatic oligomer.

7. The composition of claim 1, wherein the thermally curable aromatic oligomer further contains one or more structural units selected from the following group of Formula (4) in the oligomer chain in addition to the thermally curable group:
X²—Ar—Y² (4)
wherein Ar is a C₄-C₃₀ aryl group; X² and Y², which are identical to or different from each other, are independently O or CO.

8. The composition of claim 7, wherein the structural unit of formula (4) are selected from the group consisting of structures of Formula (5): 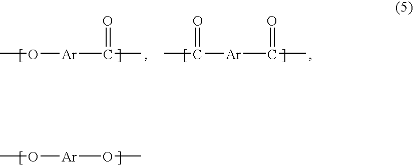
wherein each Ar is independently a C₄-C₃₀ aryl group.

9. The composition of claim 8, wherein Ar is selected from the following group of Formula (3):

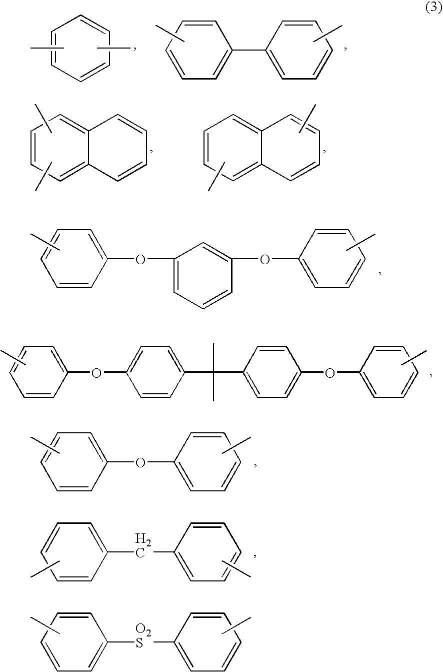

10. The composition of claim 1, wherein the thermally curable groups are thermally crosslinkable reactive groups.

11. The composition of claim 1, wherein the thermally curable groups are selected from the group consisting of maleimide, nadimide, phthalimide, acetylene, propargyl ether, benzocyclobutene, cyanate, and substituents and derivatives thereof.

12. The composition of claim 1, wherein the thermally curable aromatic oligomer is represented by Formula 7 or 8: 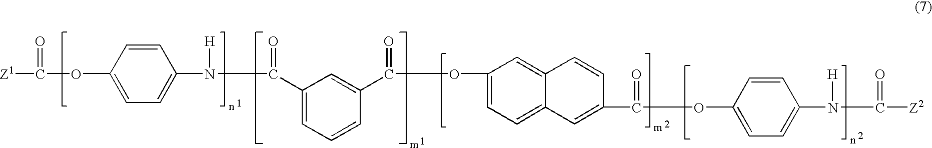
wherein Z¹ and Z², which are identical to or different from each other, are independently selected from the group consisting of maleimide, nadimide, phthalimide, acetylene, propargyl ether, benzocyclobutene, cyanate, and substituents and derivatives thereof, and and m¹, m², n¹ and n² satisfy the relations of 1≦m₁+m₂≦50, 1≦n₁+n₂≦50; 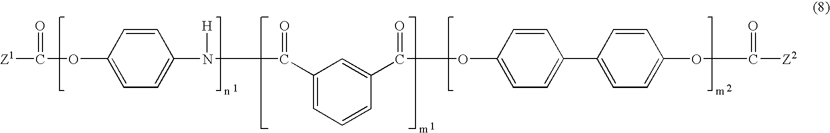
wherein Z¹ and Z², which are identical to or different from each other, are independently selected from the group consisting of maleimide, nadimide, phthalimide, acetylene, propargyl ether, benzocyclobutene, cyanate, and substituents and derivatives thereof, and m¹, m² and n¹ satisfy the relations of 1≦m₁+m₂≦50, 1≦n₁≦50;

13. The composition of claim 1, wherein the thermally curable aromatic oligomer has a number average molecular weight of 500 to 15,000 g/mol.

14. The composition of claim 1, wherein the solvent is a polar aprotic solvent.

15. The composition of claim 14, wherein the polar aprotic solvent is selected from the group consisting of N,N-dimethylacetamide, N-methylpyrrolidone (NMP), N-methylcaprolactam, N,N-dimethylformamide, N,N-diethylformamide, N,N-diethylacetamide, N-methylpropionamide, dimethylsulfoxide, y-butyrolactone, dimethylimidazolidinone, tetramethylphosphoramide, ethyl cellosolve acetate, and mixtures thereof.

16. The composition of claim 1, wherein the composition comprises 100 parts by weight of the solvent and 0.1 to 300 parts by weight of the thermally curable aromatic oligomer based on 100 parts by weight of the solvent.

17. The composition of claim 1, further comprising a toughening agent.

18. The composition of claim 17, wherein the toughening agent is an aromatic polymer.

19. The composition of claim 18, wherein the aromatic polymer has a number average molecular weight of about 2,000 to about 500,000 g/mol.

20. The composition of claim 18, wherein the aromatic polymer contains one or more mesogen groups selected from the group consisting of ester, ester-amide, ester-imide, ester-ether and ester-carbonate in the backbone chain.

21. The composition of claim 17, wherein the thermally curable aromatic oligomer and the toughening agent are mixed in a weight ratio of 99.5:0.5 to 35:65.

22. The composition of claim 1, wherein the composition has a solids content of 5% to 95% by weight with respect to the weight of the whole composition.

23. A prepreg produced from the composition of claim 1.

24. A board produced from the composition of claim 1.

25. The board of claim 24, wherein the board is a printed board or a copper-coated laminate.

26. The board of claim 25, wherein the board is a copper clad laminate (CCL) or a flexible CCL.

27. A thermally curable aromatic oligomer represented by Formula 6: 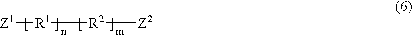
wherein R¹ is at least one soluble structural unit selected from the following structural units of Formula (2): 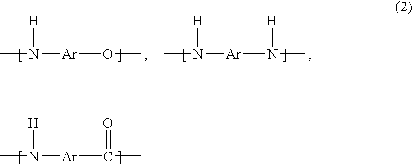
wherein each Ar is independently a C₄-C₃₀ aryl group,
R² is at least one structural unit selected from the following units of Formula (5); 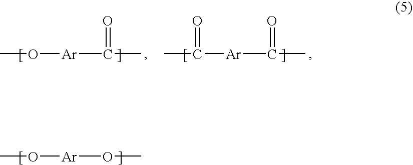
wherein each Ar is independently a C₄-C₃₀ aryl group,
Z¹ and Z², which are identical to or different from each other, each represents a group selected from the group consisting of hydrogen, halogen, hydroxyl, maleimide, nadimide, phthalimide, acetylene, propargyl ether, benzocyclobutene, cyanate, and substituents and derivatives thereof, and at least one of Z¹ and Z² are selected from the group consisting of maleimide, nadimide, phthalimide, acetylene, propargyl ether, benzocyclobutene, cyanate, and substituents and derivatives thereof; and
m and n satisfy the relations of 1≦m≦50, 1≦n≦50 and 0.05<n/(n+m+2)≦0.6.

28. A prepreg comprising the cure product of a thermally curable aromatic oligomer represented by Formula 6: 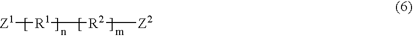
wherein R¹ is at least one soluble structural unit selected from the following structural units of Formula (2): 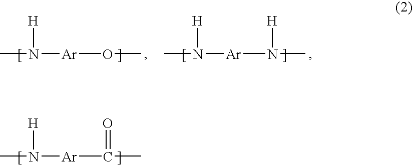
wherein each Ar is independently a C₄-C₃₀ aryl group,
R² is at least one structural unit selected from the following units of Formula (5), 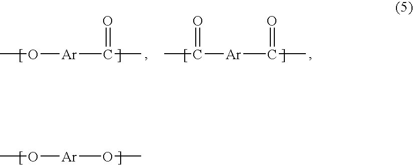
wherein each Ar is independently a C₄-C₃₀ aryl group,
Z¹ and Z², which are identical to or different from each other, each represents a group selected from the group consisting of hydrogen, halogen, hydroxyl, maleimide, nadimide, phthalimide, acetylene, propargyl ether, benzocyclobutene, cyanate, and substituents and derivatives thereof, and at least one of Z¹ and Z² are selected from the group consisting of maleimide, nadimide, phthalimide, acetylene, propargyl ether, benzocyclobutene, cyanate, and substituents and derivatives thereof, and m and n satisfy the relations of 1≦m≦50, 1≦n≦50 and 0.05<n/(n+m+2)≦0.6; and
a glass fiber cloth.

29. A prepreg comprising the cure product of a thermally curable aromatic oligomer containing at least one soluble structural unit in the backbone and at least one end of the thermally curable oligomer comprises a thermally curable group, and a glass fiber cloth,
wherein the soluble structural unit comprises one or more structural units selected from the following group of Formula (1):
X¹—Ar—Y¹ (1)
wherein Ar is a C₄-C₃₀ aryl group; X¹ and Y¹, which are identical to or different from each other, are independently selected from the group consisting of O, NR and CO, wherein at least one of the group consisting of X¹ and Y¹ is NR, wherein R is selected from the group consisting of hydrogen atom, C₁-C₂₀ alkyl group, and C₆-C₃₀ aryl group, and
wherein the thermally curable group is selected from the group consisting of maleimide, nadimide, phthalimide, acetylene, propargyl ether, benzocyclobutene, cyanate, and substituents and derivatives thereof.

30. A board comprising the prepreg of claim 29, wherein the board is a printed board or a copper-coated laminate.
